(19) United States
(12) Patent Application Publication
(10) Pub. No.: US 2025/0315213 A1
(43) Pub. Date: Oct. 9, 2025

(54) COMPUTING DEVICES WITH TRANSPOSE OPERATIONS

(71) Applicant: UNTETHER AI CORPORATION, Toronto (CA)

(72) Inventors: Francois BOUCHER, Verdun (CA); Vladimir Isaac BRONSTEIN, Redwood City, CA (US)

(21) Appl. No.: 18/813,796

(22) Filed: Aug. 23, 2024

Related U.S. Application Data
(60) Provisional application No. 63/575,362, filed on Apr. 5, 2024.

(51) Int. Cl. G06F 7/78; G06F 15/80

(52) U.S. Cl. CPC G06F 7/78; G06F 15/80

(57) ABSTRACT

The present specification discloses a computing device designed for efficiently transposing an N×N matrix using a spatial architecture of processing elements (PEs). The device can include a plurality of PEs arranged, literally or representatively, in a two-dimensional grid, each PE configured to store a single element of the matrix. A controller initializes the matrix across the PEs and sequentially increases the sub-matrix size, performing boundary calculations and data swaps within the PEs. The controller utilizes hardware primitives to facilitate parallel processing and lower compute cycles. The device adapts to various matrix shapes by padding them to the nearest N×N configuration, optimizing data distribution across the PEs.

### CROSS-RELATED APPLICATIONS

The present specification claims priority to U.S. Provisional Patent Application 63/575,362, filed Apr. 5, 2024, titled Transpose on Spatial Architecture. The contents are incorporated herein by reference.

### BACKGROUND

Transpose operations are used in various applications, including neural network models, where they involve rearranging multidimensional data tensors from one layout to another.

Existing hardware architectures for performing transpose operations often struggle with efficiency, especially when dealing with large matrices and high-dimensional data. These hardware architectures can be processor-intensive and time-consuming, primarily due to the need to move large amounts of data between different memory addresses. Additionally, current hardware architectures may not optimally support the parallel processing required for efficient transpose operations, leading to bottlenecks and suboptimal performance.

### SUMMARY

The present specification discloses a computing device designed for efficiently transposing an N×N matrix using a spatial architecture of processing elements (PEs). The device can include a plurality of PEs arranged, literally or representatively, in a two-dimensional grid, each PE configured to store a single element of the matrix. A controller initializes the matrix across the PEs and sequentially increases the sub-matrix size, performing boundary calculations and data swaps within the PEs. The controller utilizes hardware primitives to facilitate parallel processing and lower compute cycles. The device adapts to various matrix shapes by padding them to the nearest N×N configuration, optimizing data distribution across the PEs.

An aspect of the specification provides a computing device for transposing an N×N matrix, the device including: a plurality of processing elements (PEs), each PE configured to store a single element of the N×N matrix; a controller configured to: initialize the N×N matrix across the plurality of PEs, with each PE storing a single element of the matrix; set an initial sub-matrix size to 2×2; calculate boundaries for a first portion and a second portion of the initial sub-matrix; instruct the PEs to swap the content of the first portion with the second portion within the current boundaries of the sub-matrix; increase the sub-matrix size to the next power of two; repeat the steps of calculating boundaries, instructing the PEs to swap, and increasing the sub-matrix size until the current sub-matrix size is greater than or equal to N×N, thereby completing the transpose operation for the entire matrix.

An aspect of the specification provides a computing device, wherein: the first portion of the sub-matrix includes the bottom left quarter of the sub-matrix; and the second portion of the sub-matrix includes the top right quarter of the sub-matrix.

An aspect of the specification provides a computing device, wherein the controller is further configured to: initialize the N×N matrix such that each row of the matrix is stored across a row of PEs.

An aspect of the specification provides a computing device, wherein the controller is configured to: increase the sub-matrix size by doubling until the sub-matrix encompasses the entire N×N matrix.

An aspect of the specification provides a computing device, wherein: the boundaries of the sub-matrix are calculated using precomputed masks stored in memory accessible to the PEs.

An aspect of the specification provides a computing device, wherein the controller is further configured to: perform the transpose operation in parallel across the PEs using hardware primitives.

An aspect of the specification provides a computing device wherein the hardware primitives include one or more of:—MOVE PE(reg)->MEM(addr), —MOVE MEM(addr)->PE(reg)—ROTATE(direction, positions)—rotate data across PEs in a well-known register in the direction of “direction” (left or right) for a number of PE positions in “positions”.

An aspect of the specification provides a computing device, wherein the controller is further configured to: rotate data across PEs in a specified direction and distance to facilitate the transpose operation.

An aspect of the specification provides a computing device, wherein: the PEs are arranged in a two-dimensional grid, and the transpose operation involves swapping data across both row and column directions.

An aspect of the specification provides a computing device, wherein the controller is further configured to: Initialize matrices of different shapes by padding them to the nearest N×N shape for the transpose operation.

An aspect of the specification provides a computing device, wherein: the controller is configured to distribute data across the PEs such that each PE stores a portion of the matrix corresponding to its position in the grid.

An aspect of the specification provides a computing device, wherein: the PEs include memory dedicated to storing the elements of the matrix and registers for temporary data storage during the transpose operation.

An aspect of the specification provides a computing device, wherein: the transpose operation is performed in a minimum number of compute cycles by executing hardware primitives in parallel across all PEs.

An aspect of the specification provides a computing device, wherein the controller is further configured to: dynamically adjust the data distribution across the PEs to optimize the performance of the transpose operation based on the size and shape of the input matrix.

### BRIEF DESCRIPTION OF THE DRAWINGS

FIG. 1 is a diagram of an example computing device with transpose operations including a plurality of processing elements (PE)s.

FIG. 2 is a flowchart of a method for operating a computing device, such as the device of FIG. 1, to effect transpose operations.

FIG. 3 shows an example performance of the method of FIG. 2.

### DETAILED DESCRIPTION

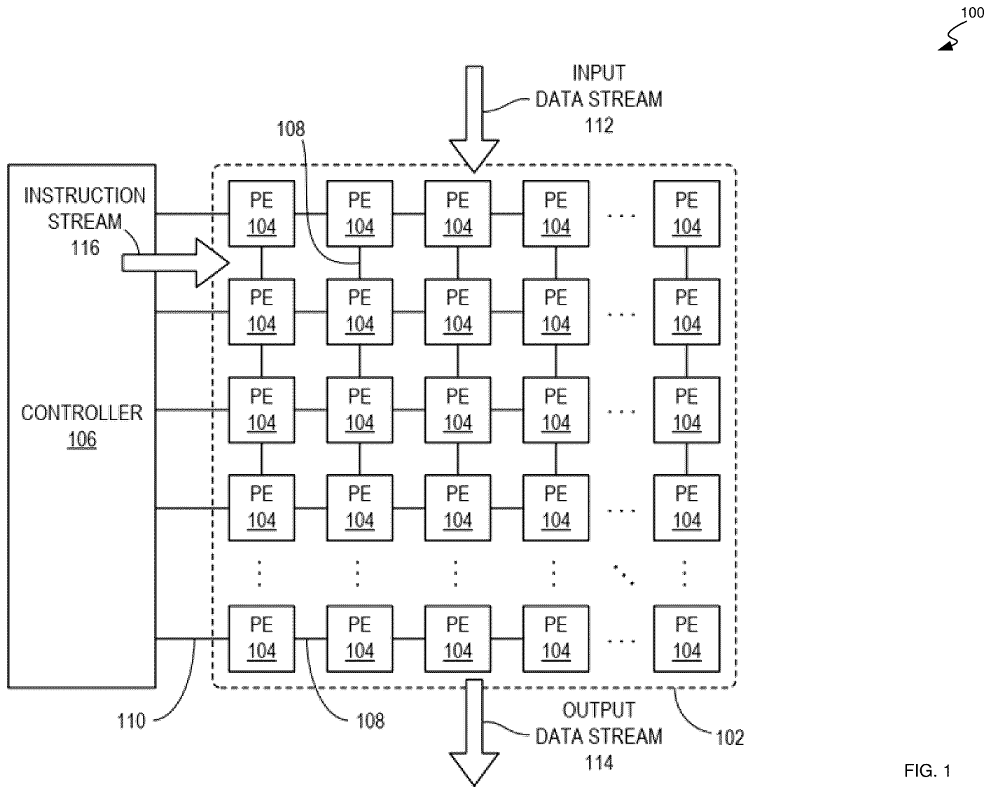

FIG. 1 shows an example computing device 100 that includes an array 102 of processing elements 104 controlled by a controller 106. The computing device 100 may be an SIMD computing device, at-memory computing device, or spatial-architecture computing device. U.S. Pat. No. 11,881,872, which is incorporated herein by reference, may be referenced for additional possible configurations concerning the device 100.

The array 102 of processing elements 104 (without the controller 106) may be referred to as a “bank.” Alternatively, the controller 106 and array 102 may together be referred to as a “bank.” Multiple banks may be connected together to form a computing device with higher processing capacity.

The processing elements or PEs 104 may be logically and, optionally, physically arranged in a two-dimensional grid. Such an array 102 may be considered to have rows and columns.

Each processing element 104 includes circuitry to perform one or more operations, such as addition, multiplication, bit shifting, multiplying accumulations, etc. By way of non-limiting example, each processing element 104 may include a multiplying accumulator and supporting circuitry. A processing element 104 may additionally or alternatively include an arithmetic logic unit (ALU) or similar.

Each processing element 104 includes or is connected to working memory dedicated to that processing element 104. Shared memory may also be provided. A processing element 104 may be connected with one or more neighboring processing elements 104 to share data and/or instructions. Processing element interconnections 108 may be provided in the row direction, the column direction, or both.

The controller 106 is connected to a subset of processing elements 104, such by interconnections 110, which may include a bus and may additionally include a direction connection to an outermost row or column of PEs 104 or several outermost rows or columns of PEs 104. The controller 106 is a processor (e.g., microcontroller, etc.) that may be configured with instructions to control the connected processing elements 104.

The controller 106 controls the connected processing elements 104 to perform various options. For example, each processing element 104 may hold two numbers, X and Y, and the controller 106 may instruct the processing elements 104 to each add their individual values of X and Y at the same time. Other example operations will become apparent to those of skill in the art.

The controller 106 may further control loading/retrieving of data to/from the processing elements 104, control the communication among processing elements 104, and/or control other functions for the processing elements 104. Any suitable number of controllers 106 may be provided to control the processing elements 104. Controllers 106 may be connected to each other for mutual communications. Controllers 106 may be arranged in a hierarchy, in which, for example, a main controller controls sub-controllers, which in turn control subsets of processing elements 104.

The array 102 of processing elements 104 may operate on an input stream of data 112, which may be marched through the processing elements 104 via interconnections 108 and undergo simultaneous operations by the processing elements 104 to generate a resulting output stream of data 114. This may occur with data movement in one direction of the array 102, as illustrated, or may involve more complex movement of data among processing elements 104.

The controller 106 may provide a stream of instructions 116 to the processing elements 104 via the interconnections 110 and may command the processing elements 104 to execute the instructions in a simultaneous/parallel manner on their respective elements of data.

During operation, any of the processing elements 104 may be blocked if there is no data ready or no instruction provided. A block processing element 104 may block one or more other processing elements 104 that require a result from the block processing element 104. Also, it may be the case that the specific computation specified by the instruction dictates the time it takes.

Hence, for a stream of instructions 116, the total time to execute may vary. Often, there is data dependency between processing elements 104 or subsets of processing elements. Further, when multiple processing-element arrays 102 or devices 100 are connected to operate together, the total amount of time to execute instructions across such processing-element arrays 102 or devices 100 may become highly interdependent.

The processing elements 104 and controller 106 are simplified for sake of explanation. The above indicated US patent may be referenced for further details.

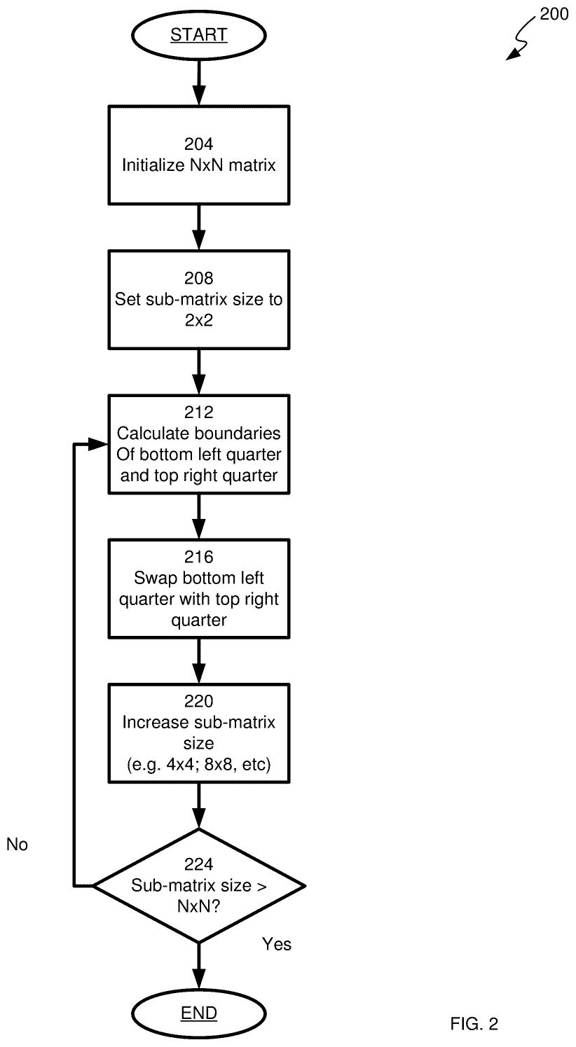

Referring now to FIG. 2, a method 200 is depicted in the form of a flowchart for operating a computing device to effect transpose operations. Method 200 can be used to control device 100 or a variant thereof. When method 200 is implemented on computing device 100, method 200 is performed by controller 106.

Block 204 comprises initializing an N×N matrix across the plurality of processing elements (PEs) 104 in the array 102 shown in FIG. 1. Each PE 104 stores a single element of the matrix, or in other embodiments, each PE 104 can store a subset of elements. Block 204 sets up the initial data distribution across the PEs 104, ensuring that each PE 104 holds one part of the overall matrix to be transposed.

Block 208 comprises setting the initial sub-matrix size to 2×2. Block 208 prepares the matrix for the initial swapping operations by defining the smallest sub-matrix that will be processed first. The controller 106 in FIG. 1 configures this sub-matrix size through the instruction stream 116.

Block 212 comprises calculating the boundaries of the bottom left quarter and the top right quarter of the initial sub-matrix. Block 212 identifies the specific portions of the matrix that will be involved in the swapping operations for the current sub-matrix size. The controller 106 coordinates this calculation and communicates it to the PEs 104 via interconnections 110.

Block 216 comprises instructing the PEs 104 to swap the content of the bottom left quarter with the top right quarter within the current boundaries of the sub-matrix. Block 216 executes the core transpose operation for the current sub-matrix size. The controller 106 sends specific instructions through the instruction stream 116 to perform this swap.

Block 220 comprises increasing the sub-matrix size to the next power of two, such as 4×4, 8×8, etc. Block 220 prepares the matrix for the next level of swapping operations by expanding the sub-matrix size incrementally. The controller 106 updates the sub-matrix size and communicates the new size to the PEs 104.

Block 224 comprises determining whether the current sub-matrix size is greater than N×N. The decision at block 224 determines whether the transpose operation should continue with a larger sub-matrix size or terminate if the entire matrix has been processed. The controller 106 performs this check and decides whether to loop back to block 212 to calculate new boundaries and perform additional swaps, or to end method 200.

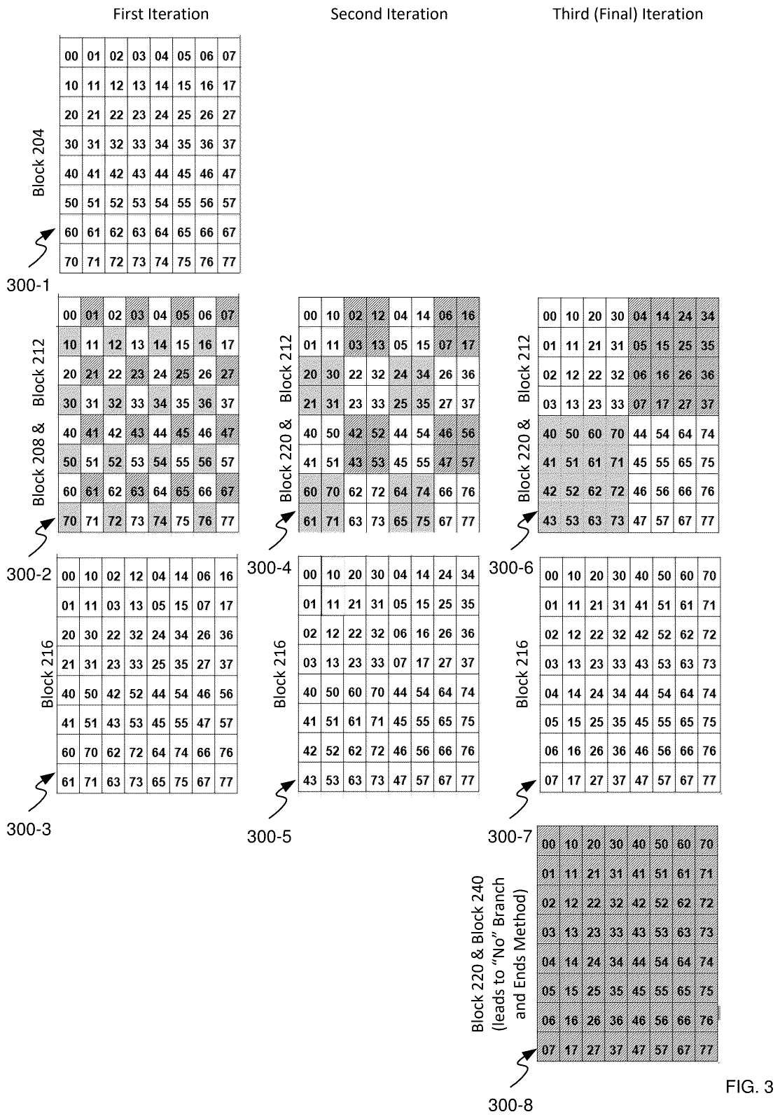

FIG. 3 shows an example performance of method 200 on a matrix 300. Matrix 300 is represented in different stages, with stage 1 labeled as matrix 300-1, stage 2 labeled as matrix 300-2, etc.

Matrix 300-1 represents the initial matrix setup as performed in block 204. The N×N matrix is distributed across the PEs 104 in the array 102, with each PE storing a single element. This stage sets the foundation for the subsequent transpose operations. According to the example matrix 300, N×N equals 8×8.

Matrix 300-2 illustrates the result of block 208, where the sub-matrix size is set to 2×2. The boundaries of the initial sub-matrix are calculated, and the specific sections of the matrix to be swapped are identified. The boundaries are defined by 2×2 regions, and the shading highlights the areas within these boundaries that will be swapped.

Matrix 300-3 demonstrates the performance of block 216 for the first iteration. The content of the bottom left quarter is swapped with the top right quarter within the 2×2 sub-matrix. The controller 106 instructs the PEs 104 to execute the swap using the instruction stream 116.

Matrix 300-4 depicts the result of block 220, where the sub-matrix size is increased to 4×4. The new boundaries are calculated, per block 212, and the matrix is prepared for the next level of swapping operations. The boundaries are defined by 4×4 regions, and the shading highlights the new areas to be swapped.

Matrix 300-5 shows the performance of block 216 for the second iteration. The content of the bottom left quarter is swapped with the top right quarter within the 4×4 sub-matrix.

Matrix 300-6 illustrates the result of block 220, where the sub-matrix size is further increased to 8×8. The boundaries are recalculated to accommodate the larger sub-matrix size. The boundary is defined by the entire 8×8 region, with the shading highlighting the specific areas involved in the swapping operation.

Matrix 300-7 demonstrates the performance of block 216 for the final iteration. The content of the bottom left quarter is swapped with the top right quarter within the 8×8 sub-matrix. This final swap completes the transpose operation for the entire matrix. The shading shows the final swapped areas within the 8×8 boundaries.

Matrix 300-8 represents the final transposed matrix, its contents being the same as matrix 300-7, resulting from the series of operations performed in blocks 204 through 224. The shading in matrix 300-8 highlights indicates that further expansion of the sub-matrix leads to no more swappable regions, thus bringing method 200 to its conclusion. The controller 106 ensures that the entire matrix has been correctly transposed, and the method 200 ends with a fully processed N×N (i.e., 8×8) matrix.

Example code for method 200 usable by controller 106 is reproduced in Table I:

```
TABLE 1
for k in range(log2(N)):
  MOVE(REG(M), MEM(mask + k))
  distance = pow(2, k)
  for i in range(0, N, distance):
    for j in range(distance):
      MOVE(REG(A), MEM(i + j))
      MOVE(REG(B), MEM(i + j + distance))
      ROTATE(REG(A), direction=left, distance=distance)
      ROTATE(REG(B), direction=right, distance=distance)
      MOVE(MEM(i + j), REG(B), condition=(M==1))
      MOVE(MEM(i + j + distance), REG(A), condition=(M==0))
```

The foregoing example code in Table I contemplates the use of hardware primitives that can be native to controller 106.

Where:

MOVE(y, x [, condition]): Move x value into y, with optional condition

ROTATE(x, direction, distance):

Send value x to the PE located at the given direction and distance.

Receive the value sent by PE located in the opposite direction, at the same distance.

Values coming from outside the PE range are considered as undefined.

To elaborate, the hardware primitives available on the platform and used for transposition include:

MOVE PE(reg)->MEM(addr): Move a unit of data (byte) from a specific PE register to a PE memory address.

MOVE MEM(addr)->PE(reg): Move a unit of data from a specific PE memory address to a PE register.

ROTATE(direction, positions): Rotate data across PEs in a well-known register in the direction of “direction” (left or right) for a number of PE positions in “positions.”

### Memory:

addresses 0-N contain for each PE the N×1 values each PE possess
addresses “mask+k” contain some precomputed masks:

### Example of Masks for N=8:

[[0, 1, 0, 1, 0, 1, 0, 1],
[0, 0, 1, 1, 0, 0, 1, 1],
[0, 0, 0, 0, 1, 1, 1, 1]]

It should be recognized that features and aspects of the various examples provided above can be varied and/or combined into further examples that also fall within the scope of the present disclosure. For example, method 200 described herein is highly versatile and can be applied to any matrix with an N×N shape, provided that N is a power of 2 and that the number of processing elements (PEs 104) matches N. This compatibility ensures that the algorithm can effectively utilize the hardware resources to perform the transpose operation efficiently.

Additionally, method 200 is adaptable to handle matrices of different shapes by padding them to the nearest N×N shape. This flexibility allows for the processing of non-square matrices or matrices whose dimensions are not initially powers of 2, by extending them appropriately.

Method 200 can also be extended to process matrices of size M×M′, where both M and M′ are multiples of N. In such cases, extra swaps can be used to complete the transpose operation. However, these additional swaps do not necessitate communication between PEs 104, as the data to be swapped resides within the same PE 104 at different memory locations.

The data distribution across the PEs 104 can be adjusted to suit different configurations. For example, the data can be split between PEs 104 in various ways, allowing for flexible and efficient use of hardware resources:

In an example configuration, sixty-four PEs 104 can be used to hold 1×64 of the data, meaning each PE 104 can store a single column vector of the matrix.

Alternatively, a 64×64 matrix of PEs 104 can be used, where each PE 104 holds a single value in memory. This configuration distributes the entire matrix across the PEs 104, with each PE 104 responsible for one element of the matrix.

Another possible configuration is an 8×64 matrix of PEs 104, where each PE 104 holds an 8×1 subset of the data. This approach combines aspects of both previous configurations, allowing for efficient data handling and parallel processing.

These examples illustrate the method 200 and the associated algorithm's adaptability and the various ways in which data can be distributed across PEs 104 to optimize performance. The flexibility in data distribution ensures that the algorithm can be effectively applied to a wide range of matrix sizes and shapes, leveraging the capabilities of the underlying hardware architecture.

The present specification thus provides a novel device and method for transposition that solves various technical problems encountered in existing hardware architectures. For context, as person of skill in the art will recognize that a transpose operation in a general sense is an operation in a Neural Network Model that takes a multidimensional data tensor laid out in one shape (e.g., M×N×R) and returns the same data laid out in a different shape, with dimensions reshuffled (e.g., N×M×R). If the data is located in sequential addresses in memory, with the last dimension being closest in memory addresses, the data needs to be moved around for such an operation.

In a spatial architecture as described herein, the present specification is primarily concerned with two dimensions of a tensor as laid out in PE memory—one dimension across PEs in a PE Row arrangement and another within each PE's memory address. In the example architecture, we have a row of N PEs, each PE having M memory entries. The problem addressed by the present specification is transposing N×R matrix data in row memory into R×N matrix data in the same memory, where R=N and R<M. For example, with N=64, the same approach can be extended to any power of 2 number of PEs in a PE row.

Thus, one problem addressed by the present specification can be stated as follows: given a two-dimensional square matrix of N×N in row PE's memory, transposition needs to be done in a low or reduced number of compute cycles using hardware primitives available on the platform. Hardware primitives can be executed in the same way on all PEs in parallel.

The scope of the present specification is defined by the claims attached hereto.

1. A computing device for transposing an N×N matrix, the device comprising:
a plurality of processing elements (PEs), each PE configured to store a single element of the N×N matrix;
a controller configured to:
initialize the N×N matrix across the plurality of PEs, with each PE storing a single element of the matrix;
set an initial sub-matrix size to 2×2;
calculate boundaries for a first portion and a second portion of the initial sub-matrix;
instruct the PEs to swap the content of the first portion with the second portion within the current boundaries of the sub-matrix;
increase the sub-matrix size to the next power of two;
repeat the steps of calculating boundaries, instructing the PEs to swap, and increasing the sub-matrix size until the current sub-matrix size is greater than or equal to N×N, thereby completing the transpose operation for the entire matrix.

2. The computing device of claim 1, wherein:
the first portion of the sub-matrix comprises the bottom left quarter of the sub-matrix; and
the second portion of the sub-matrix comprises the top right quarter of the sub-matrix.

3. The computing device of claim 1, wherein the controller is further configured to:
initialize the N×N matrix such that each row of the matrix is stored across a row of PEs.

4. The computing device of claim 1, wherein the controller is configured to:
increase the sub-matrix size by doubling until the sub-matrix encompasses the entire N×N matrix.

5. The computing device of claim 1, wherein:
the boundaries of the sub-matrix are calculated using precomputed masks stored in memory accessible to the PEs.

6. The computing device of claim 1, wherein the controller is further configured to:
perform the transpose operation in parallel across the PEs using hardware primitives.

7. The computing device of claim 6 wherein the hardware primitives include one or more of:
MOVE PE(reg)->MEM(addr),
MOVE MEM(addr)->PE(reg)
ROTATE(direction, positions)—rotate data across PEs in a well-known register in the direction of “direction” (left or right) for a number of PE positions in “positions”.

8. The computing device of claim 1, wherein the controller is further configured to:
rotate data across PEs in a specified direction and distance to facilitate the transpose operation.

9. The computing device of claim 1, wherein:
the PEs are arranged in a two-dimensional grid, and the transpose operation involves swapping data across both row and column directions.

10. The computing device of claim 1, wherein the controller is further configured to:
Initialize matrices of different shapes by padding them to the nearest N×N shape for the transpose operation.

11. The computing device of claim 1, wherein:
the controller is configured to distribute data across the PEs such that each PE stores a portion of the matrix corresponding to its position in the grid.

12. The computing device of claim 1, wherein:
the PEs include memory dedicated to storing the elements of the matrix and registers for temporary data storage during the transpose operation.

13. The computing device of claim 1, wherein:
the transpose operation is performed in a minimum number of compute cycles by executing hardware primitives in parallel across all PEs.

14. The computing device of claim 1, wherein the controller is further configured to:
dynamically adjust the data distribution across the PEs to optimize the performance of the transpose operation based on the size and shape of the input matrix.
